(19) United States
(12) Patent Application Publication
(10) Pub. No.: US 2013/0345095 A1
(43) Pub. Date: Dec. 26, 2013

(54) METHOD AND DEVICE FOR ASSEMBLING GENOME SEQUENCE

(71) Applicants: Changlei Han, Shenzhen (CN); Wenbin Chen, Shenzhen (CN); Xiuqing Zhang, Shenzhen (CN); Huanming Yang, Shenzhen (CN)

(72) Inventors: Changlei Han, Shenzhen (CN); Wenbin Chen, Shenzhen (CN); Xiuqing Zhang, Shenzhen (CN); Huanming Yang, Shenzhen (CN)

(73) Assignee: BGI TECH SOLUTIONS CO., LTD., Shenzhen (CN)

(21) Appl. No.: 14/002,374

(22) PCT Filed: Mar. 2, 2012
(86) PCT No.: PCT/CN2012/071876

§ 371 Date: Aug. 30, 2013

(30) Foreign Application Priority Data
Mar. 2, 2011 (CN) 201110019885.0

(51) Int. Cl. G06F 19/18

(52) U.S. Cl. CPC G06F 19/18
USPC 506/24; 506/40

(57) ABSTRACT

A method and an apparatus for genome assembly are provided. The method comprises: filtering a short-fragment-sequence output from end sequencing of an large insert-size library to remove unqualified sequence; aligning the filtered short-fragment-sequence onto a reference genome sequence, wherein, the filtered short-fragment-sequences comprise paired short-fragment-sequences; sorting the paired short-fragment-sequence after alignment into soap reads sequence, single reads sequence and unmap reads sequence based on the aligning result, and counting the number of each sort of sequence; calculating a distance between the paired soap reads on a fragment of the reference genome sequence, wherein a pair of the paired soap reads can be aligned onto a same fragment of the reference genome sequence; and counting a distance distribution of each pair of soap reads on the reference genome sequence; and assembling the genome sequence by using the paired single reads upon the distance distribution meeting a requirement of a threshold, wherein a pair of the paired single reads can be aligned onto two different fragments of the reference genome sequence.

### CROSS-REFERENCE TO RELATED APPLICATIONS

This application claims the priority to and benefits from Chinese Patent Application No. 201110049885.0 filed with the State Intellectual Property Office, P. R. C. on Mar. 2, 2011, the content of which is incorporated herein by reference in its entirety.

### FIELD

The present disclosure relates to the field of biological information technology, particularly to a method of assembling a genome sequence and an apparatus thereof.

### BACKGROUND

While the throughput of sequencing is increasing, the cost of sequencing decreases sharply with the emergence of next generation sequencing technology, such as 454 (Roche), Solexa (Illumina) and SOLiD (ABI). The next-generation sequencing technology has greatly promoted the development of Genomics. Whole genome sequences of a large number species have been published, including the personal genome of James Watson, the first Asian genome, and genomes of giant panda and cucumber.

Each round of sequencing of a next generation sequencing instruments can generate millions of short fragment sequences. Typically, subjecting a genome to a completely sequenced needs multiple rounds of sequencing work, which means that, in order to obtain a whole genome-wide map, millions or even billions of short fragment sequences may need to be plotted, positioned, and jointed.

Therefore, current method of genome assembly needs to be improved.

### SUMMARY

The present disclosure is based on the following findings of the inventors:

At present, when using a next generation sequencing technology for sequencing, the output can be all short fragment sequences having a length of about 25 by to about 100 bp. These short-fragment-sequences are some parts of large-fragments of a sample to be tested. Subjecting massive amounts of short-fragment-sequences data obtained from sequencing for assembly and restoring to large-fragment data for subsequent information analysis is a great challenge. In the prior art, because the fragment-sequences output from sequencing can be very short, the restoration of large-fragment data can need a large amount of calculation.

At the same time, the indicator of fragment-length N50 as a measurement of genome quality can also be restricted with the length of inserted fragment for constructing a library in an experiment. (N50 refers to a length which is equivalent to 50% of overall length, obtained by putting and adding all assembled sequences in a descending order. Detailed description regarding to N50 reference is made to Miller et al. 2010. Assembly Algorithms for Next Generation Sequencing data. Genomics. 95 (6): 315-327, which is incorporated herein by reference).

The present disclosure directs to solve at least one of the problems existing in the prior art.

Therefore, the present disclosure provides a method and an apparatus which may be used for genome assembly, so as to utilize short-fragment-sequence of end sequencing of large insert-size library to assemble genome, so that the efficiency and effect of assembly may be improved.

According to one aspect of the present disclosure, the present disclosure provides a method for genome assembly. According to an embodiment of the present disclosure, a method for genome assembly comprises: filtering short-fragment-sequences output from end sequencing of a large insert-size library to remove unqualified sequence; aligning the filtered short-fragment-sequence to a reference genome sequence, wherein, the filtered short-fragment-sequence comprises paired short-fragment-sequence; sorting the paired short-fragment-sequence after alignment into soap reads sequence, single reads sequence and unmap reads sequence based on the aligning result, and counting the number of each sort of sequence; calculating a distance between the paired soap reads on a fragment of the reference genome, wherein a pair of the paired soap reads can be aligned onto a same fragment of the reference genome sequence; and counting a distance distribution of each pair of soap reads on the reference genome sequence; and assembling the genome sequence by using the paired single reads upon the distance distribution meeting a requirement of a threshold, wherein a pair of the paired single reads can be aligned onto two different fragments of the reference genome sequence. Thus, the efficiency and effect of genome assembly may be improved.

According to embodiment of the present disclosure, the method for genome assembly may also comprise following additional technical features.

According to an embodiment of the present disclosure, the filtered short-fragment-sequence comprises paired short-fragment-sequence. Thus, the efficiency of genome assembly may be further improved.

According to an embodiment of the present disclosure, before aligning the filtered short-fragment-sequence to a reference genome sequence, the method further comprises intercepting the filtered short-fragment-sequence to short-fragment-sequences with a preset length. Thus, the efficiency of genome assembly may be further improved.

According to an embodiment of the present disclosure, the unqualified sequence comprises at least one selected from a group consisting of: an exogenous sequence, a short-fragment-sequence having a preset number of low-grade bases, a short-fragment-sequence comprising poly A, a short-fragment-sequence having a contaminant from adaptor, a short-fragment-sequence having an overlap with its paired short-fragment-sequence, and a short-fragment-sequence repeatedly detected. Thus, the efficiency of a genome assembly may be further improved.

According to an embodiment of the present disclosure, the soap reads sequence comprising paired reads can be uniquely aligned onto the same fragment of the reference genome sequence, and paired reads can be non-uniquely aligned onto the same fragment-sequence of the reference genome sequence; the step of calculating a distance between the paired soap reads on a fragment of the reference genome, wherein a pair of the paired soap reads can be aligned on a same fragment of the reference genome, further comprising: calculating the distance between the paired soap reads uniquely aligned onto a same fragment of the reference genome. Thus, the efficiency of genome assembly may be further improved.

According to an embodiment of the present disclosure, the method further comprises: constructing a large insert-size-sequence library; and end-sequencing the large insert-size-sequence library to obtain the output short-fragment-sequence, which is a benefit for assembling longer fragment-sequence of genome sequence.

According another aspect of the present disclosure, the present disclosure provides an apparatus for genome assembly. According to embodiment of the present disclosure, the apparatus for genome assembly comprises: a sequence-filtering unit for filtering a short-fragment-sequence output from end sequencing of an large insert-size-sequence library to remove unqualified sequence; a sequence-aligning unit, connected to the sequence-filtering unit, for aligning the filtered short-fragment-sequence to a reference genome sequence, wherein the filtered short-fragment-sequence comprises paired short-fragment-sequence; a sequence-sorting unit, connected to the sequence-aligning unit, for sorting the paired short-fragment-sequence after alignment into soap reads sequence, single reads sequence and unmap reads sequence based on the aligning result, and counting the number of each sort of sequence; a sequence-length-calculating unit, connected to the sequence-sorting unit, for calculating a distance between the paired soap reads on a fragment of the reference genome sequence, wherein a pair of the paired soap reads can be aligned onto a same fragment of the reference genome sequence; and counting a distance distribution of each pair of soap reads on the reference genome sequence; and a sequence-assembling unit, respectively connected to the sequence-sorting unit and the sequence-length-calculating unit, for assembling the genome sequence by using the paired single reads upon the distance distribution meeting a requirement of a threshold, wherein a pair of the paired single reads can be aligned onto two different fragments of the reference genome sequence. The above method for genome assembly may be effectively carried out by using the apparatus for genome assembly, so the short-fragment-sequences obtained from end-sequencing of large insert-size-sequence library may be utilized to genome assembly, thus the effect and efficiency of the assembly may be improved.

According to embodiment of the present disclosure, the apparatus for genome assembly may also comprise following additional technical features:

According to an embodiment of the present disclosure, the apparatus for genome assembly of the present disclosure further comprises: a sequence-intercepting unit, respectively connected to the sequence-filtering unit and the sequence-aligning unit, for intercepting the filtered short-fragment-sequences to short-fragment-sequences with a preset length before aligning the filtered short-fragment-sequences to the reference genome sequence.

According to another embodiment of the apparatus in the present disclosure, the unqualified sequence comprises at least one selected from a group consisting of: an exogenous sequence, a short-fragment-sequence having a preset ratio of N bases, a short-fragment-sequence comprising poly A, a short-fragment-sequence having a preset number of low-quality bases, a short-fragment-sequence having a contaminant from adaptor, a short-fragment-sequence having an overlap with its paired short-fragment-sequence, and a short-fragment-sequence repeatedly detected. Thus, the efficiency of the genome assembly may be further improved.

According to a further embodiment of the apparatus in the present disclosure, the soap reads sequence comprises: paired reads that can be uniquely aligned to the same fragment of the reference genome sequence, and paired reads that can be non-uniquely aligned to the same fragment of the reference genome sequence, wherein the calculation of the distance between the paired soap reads on a same fragment of the reference genome sequence is performed by further using the paired soap reads uniquely aligned onto a same fragment of the reference genome. Thus, the quality of library may be evaluated, and the efficiency of the genome assembly may be further improved.

According to an embodiment of the apparatus in the present disclosure, the apparatus for genome assembly of the present disclosure further comprises: a sequence-receiving unit, connected to the sequence-filtering unit, for receiving the sequences after the step of end-sequencing the large insert-size library. Thus, the efficiency of the genome assembly may be further improved.

According to the method and the apparatus for genome assembly of an embodiment in the present disclosure, since the large insert-size library is subjected to end sequencing, longer fragments of genome sequence may be constructed by using a sequencing data containing a sequence-relationship with a longer distance than the prior art, and then the effect of the genome assembly is further improved.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings, in which:

FIG. 1 is a flow chart of the method for genome assembly according to an embodiment of the present disclosure;

FIG. 2 is a flow chart of the method for genome assembly according to another embodiment of the present disclosure;

FIG. 3 is a flow chart of the method for genome assembly according to a further embodiment of the present disclosure;

FIG. 4 is a flow chart of the method for genome assembly according to an additional embodiment of the present disclosure;

FIG. 5 is a library quality assessment diagram of the method for genome assembly according to an additional embodiment of the present disclosure;

FIG. 6 is a schematic diagram of the apparatus for genome assembly according to an embodiment of the present disclosure;

FIG. 7 is a schematic diagram of the apparatus for genome assembly according to another embodiment of the present disclosure; and

FIG. 8 is a schematic diagram of the apparatus for genome assembly according to a further embodiment of the present disclosure.

### DETAILED DESCRIPTION

Reference will be made in detail to embodiments of the present disclosure. The embodiments described herein with reference to the accompanying drawings are explanatory and illustrative, which are used to generally understand the present disclosure. The embodiments shall not be construed to limit the present disclosure. The same or similar elements and the elements having same or similar functions are denoted by like reference numerals throughout the descriptions.

Firstly, the method for genome assembly of the present disclosure is described in detail referring to the figures.

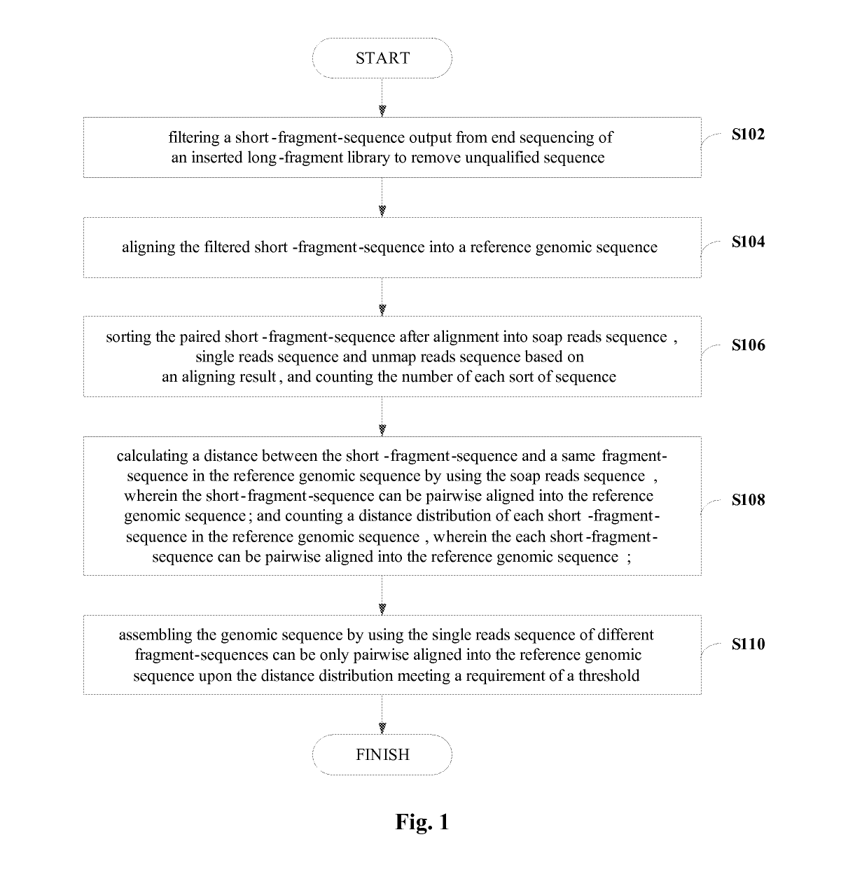

Referring to FIG. 1, according to embodiments of the present disclosure, the method for genome assembly may comprise following steps.

S102, filtering short-fragment-sequences output from end sequencing of a large insert-size library to remove unqualified sequence. The length of the term “large insert-size” used in the present disclosure is not subjected to special restrictions, it may by any inserted length achievable in the prior art, such as it may be up to at least 200 kb, or such as it may be 40 kb to 200 kb, or it may be about 100 kb to 200 kb. A person skilled in the art may easily obtain the above large insert-size by using an existing vector. For example, fosmid and bacterial artificial chromosome (BAC) both allow large DNA fragment cloning used in genome studies. Generally, BAC may be inserted with a fragment having a length of about 100 kb to 200 kb. Generally, fosmid may be inserted with a fragment having a length of about 40 kb. BAC and fosmid not only have characteristics of being able to hold a long-fragment insert, but can also be very stable. Thus, they an be two important tools in genome studies that play a vital role on genetic map cloning, genetic analysis, structural variation, and genome assembly. According to embodiments of the present disclosure, the type of unqualified sequences to be removed are not subjected to special restrictions. According to some embodiments of the present disclosure, unqualified sequences comprise at least one selected from a group consisting of: an exogenous sequence (e.g., it may be the exogenous sequence introduced by experiment, for example various adaptor sequences), a short-fragment-sequence having a preset ratio of the number of N bases (e.g., the preset ratio may be at least 10%), a short-fragment-sequence comprising poly A, a short-fragment-sequence having a preset ratio of the number of low-quality bases (bases with quality value below or equivalent to 20 given by sequencing is regarded as low-quality bases; sequences having a ratio (Q20) below or equivalent to 0.7, the Q20 is a ratio of the number of bases with quality value greater than 20 to the number of total bases), a short-fragment-sequence having a contaminant from adaptor (e.g., having a length of at least 10 by can be aligned to adaptor sequence, and the number of mismatch is no more than 3), a short-fragment-sequence having an overlapped region with its paired short-fragment-sequence, and a short-fragment-sequence repeatedly detected (the case of paired short-fragment sequence being identical is defined as repeat). The meaning of the term “paired short-fragment-sequence” used herein is that, the sequencing is performed from two ends of a insert-fragment to the inside, the obtained two ends tags are known as paired short-fragment sequence.

S104, aligning the filtered short-fragment-sequence to a reference genome sequence.

According to embodiments of the present disclosure, means for alignment can be, but is not subjected to special restriction, to methods and relevant software known as SOAP (Short Oligonucleotide Analysis Package), BWA (Burrows-Wheeler Alignment), etc.. According to embodiments of the present disclosure, the filtered short-fragment-sequence comprises paired short-fragment-sequence.

S106, sorting the paired short-fragment-sequences after alignment into soap reads sequence, single reads sequence and unmap reads sequence based on the aligning result, and counting the number of each sort of sequence. In the present disclosure, the meaning of the term “soap reads sequence” used herein refers to a paired short-fragment sequences, two sequences of a pair of soap reads can be aligned onto a same assembling-fragment of the reference genome sequence, which can also be called “paired soap reads”. The meaning of the term “single reads sequence” refers to a paired short-fragment sequences, two sequences of a pair of single reads can be aligned onto two different assembling-fragments of the reference genome sequence, which can also be called “paired single reads”. The meaning of the term “unmap reads sequence” refers to a paired short-fragment sequences, both of which cannot be aligned to any assembling-fragments of the reference genome sequence.

S108, since soap reads are paired short-fragment sequences which can be aligned to a same assembling fragment sequence of the reference genome sequence, by using the soap reads sequence, a distance between the paired short-fragment-sequences on a fragment of the reference genome sequence can be calculated, wherein the paired short-fragment-sequences aligned on a same fragment of the reference genome sequence are paired soap reads; and a distance distribution of each pair of the paired soap reads on the reference genome sequence can also be counted.

S110, upon the distance distribution meeting a requirement of a threshold (according to embodiments of the present disclosure, the specific value of the threshold is not subjected to special restriction, it may be obtained based on specific sequencing environment by a person skilled in the art though limited experiments. For example, when constructing a library by using fosmid, the threshold is a ratio of paired soap reads having a distance of 30 kb to 50 kb is more than 85%), the genome fragments are assembled by using the paired single reads, a pair of the paired single reads can be aligned onto two different fragments of the reference genome;

Specifically, the different assembled-fragments of genome may be assembled according to the insert-size and spatial relationship of the library by using the unique paired single reads which can be uniquely aligned to different assembled-fragments of the genome, to improve the effect of genome assembly.

In the embodiment of the present disclosure, as the large insert-size-sequence library is subjected to end-sequencing, so a longer genome fragment can be constructed by using a sequencing data containing a sequence relationship with longer distance comparing to existing technology, improving the efficiency of the genome assembly.

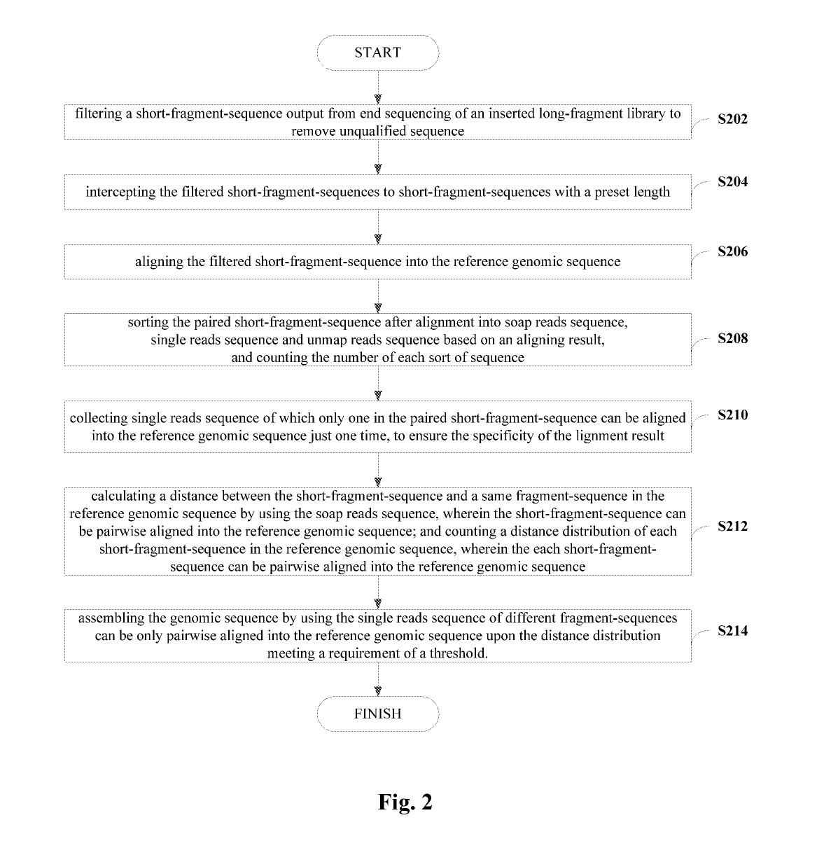

Next, a method for genome assembly according to another embodiment of the present disclosure is described in detail referring to FIG. 2.

As shown in FIG. 2, according to embodiments of the present disclosure, the method for genome assembly may comprise following steps.

S202, filtering short-fragment-sequences output from end sequencing of a large insert-size library to remove unqualified sequence.

Specifically, short-fragment-sequences after sequencing may be aligned to an exogenous sequence induced by experiment (for example, various adaptors); the short-fragment-sequences with existence of the exogenous sequence are regarded as unqualified sequences, which have to be removed. Besides, the unqualified sequences may also comprise at least one selected from a group consisting of: a short-fragment-sequence having a preset ratio of the number N bases, a short-fragment-sequence comprising poly A, a short-fragment-sequence having the number of low-quality base to a certain degree (e.g., 40 bases), a short-fragment-sequence having a contaminant from adaptor (e.g., having a length of at least 10 by can be aligned into adaptor sequence, and the number of mismatching no more than 3), a short-fragment-sequence having an overlap with its paired one (e.g., the overlap of the paired short-fragment-sequence is at least 10 bp, and a ratio of mismatching is less than 10%), and a short-fragment-sequence repeatedly detected (the case of paired short-fragment sequence being identical in sequencing is defined as repeat). Then, a short-fragment-sequence with a head or an end having a poorer quality will be directly truncated.

S204, intercepting the filtered short-fragment-sequences to short-fragment-sequences with a preset length.

Specifically, to improve the alignment accuracy, the length of the fragment to be aligned should be essentially the same, with a certain allowance of ranges (e.g., the ranges may be set by the user according to requirements). A short-fragment-sequence obtained from sequencing having a length within normal ranges is referred to as a normal short-fragment-sequence, if otherwise, is referred to as an abnormal short-fragment-sequence. According to embodiments of the present disclosure, the set length is at least 40 bp. In the case that a sequence length to be aligned is too short, the alignment efficiency may be decreased and the property of N50 may be decreased. The maximum number of mismatching in one short-fragment-sequence during the alignment should be as low as possible, to ensure the precision of the alignment.

S206, aligning the filtered short-fragment-sequences onto the reference genome sequence.

According to embodiments of the present disclosure, means for alignment is not subjected to special restrictions, for example the alignment may be aligned by using known methods and relative software such as SOAP, BWA, etc. According to embodiments of the present disclosure, the obtained filtered short-fragment-sequences comprise paired short-fragment-sequences.

S208, sorting the paired short-fragment-sequences after alignment into soap reads sequence, single reads sequence and unmap reads sequence based on an aligning result, and counting the number of each sort of sequence.

S210, collecting unique paired single reads sequences, which can be uniquely aligned onto different fragments of the reference genome sequence, to ensure the specificity of the alignment result.

S212, calculating a distance between the paired soap reads on a fragment-sequence of the reference genome sequence, wherein a pair of the paired soap reads can be aligned onto a same fragment of the reference genome; and counting a distance distribution of each paired soap reads on the reference genome sequence.

S214, upon the distance distribution meeting a requirement of a threshold (according to embodiments of the present disclosure, specific value of the threshold is not subjected to special restriction, it may be obtained based on specific sequencing environment by a person skilled in the art through limited experiments, e.g., when constructing a library by using fosmid, the threshold is a ratio of paired soap reads having a distance of 30 kb to 50 kb is more than 85%), the assembly of the genome sequence by using the unique paired single reads, which is collected in step S210, can be uniquely aligned onto different fragments of the reference genome sequence.

In this embodiment, the length of the short-fragment-sequences to be aligned is subjected to a certain definition, which requires that the length of the short-fragment-sequence to be aligned should be within a preset range to ensure the precision and efficiency of the alignment.

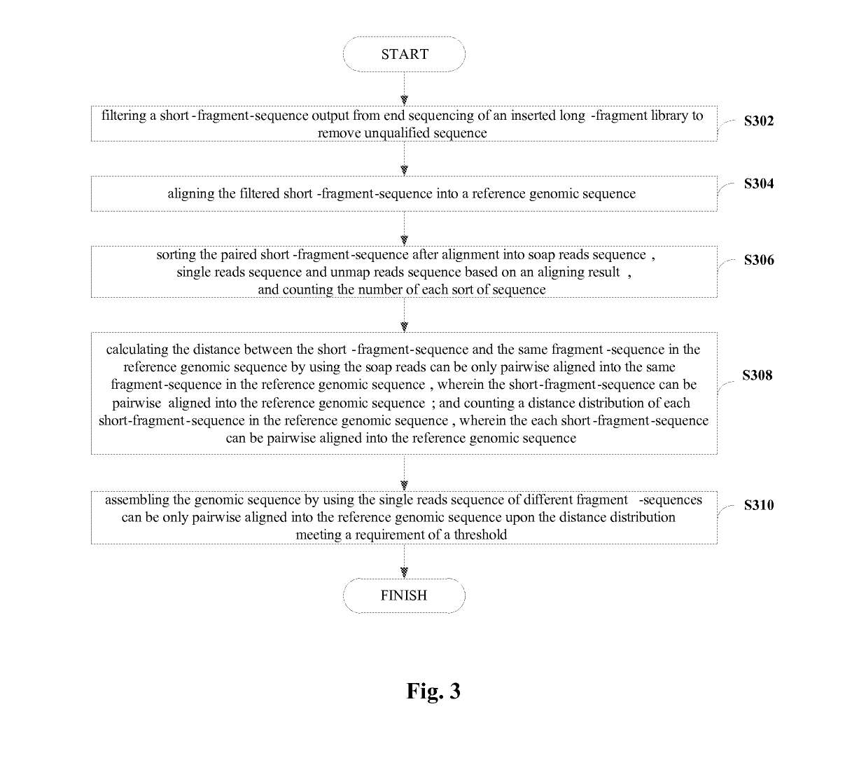

Next, a method for genome assembly according to a further embodiment of the present disclosure is described in detail referring to FIG. 3.

As shown in FIG. 3, the method for genome assembly may comprise following steps.

S302, filtering a short-fragment-sequence output from end sequencing of an large insert-size library to remove unqualified sequence.

S304, aligning the filtered short-fragment-sequences to a reference genome sequence.

S306, sorting the paired short-fragment-sequences after alignment into soap reads sequence, single reads sequence and unmap reads sequence based on the aligning result, and counting the number of each sort of sequence, wherein, the soap reads sequence comprises: paired reads can be uniquely aligned onto a same fragment of the reference genome sequence, and paired reads can be non-uniquely aligned onto a same fragment-sequence of the reference genome sequence.

S308, calculating the distance between the paired soap reads on a fragment of the reference genome sequence, wherein a pair of the paired soap reads can be uniquely aligned onto a same fragment of the reference genome sequence; and counting a distance distribution of each paired soap reads on the reference genome sequence.

S310, assembling the genome by using the unique paired single reads upon the distance distribution meeting a requirement of a threshold, wherein a pair of unique paired single reads can be uniquely aligned onto different fragments of the reference genome.

In this embodiment, the distance between the short-fragment-sequences can be calculated by using the unique paired soap reads, a pair of which can be uniquely aligned onto a same fragment of the reference genome, which can accurately count the quality of the large insert-size-sequence library to improve the accuracy of the genome assembly.

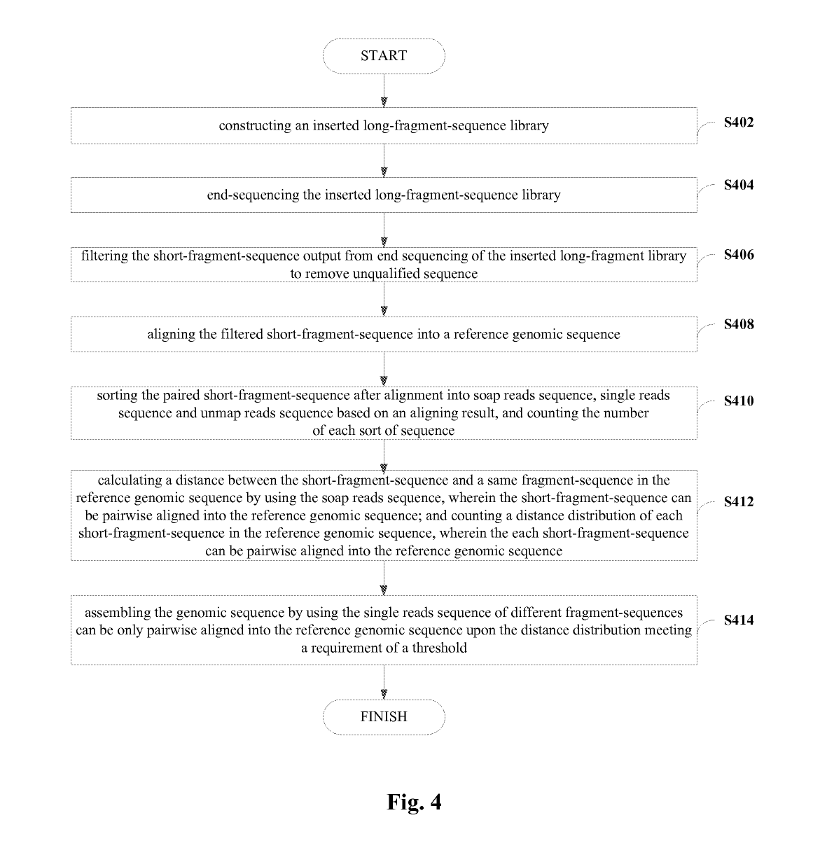

Next, a method for genome assembly according to an additional embodiment of the present disclosure is described in detail referring to FIG. 4.

As shown in FIG. 4, the method for genome assembly may comprise following steps.

S402, constructing a large insert-size library. According to embodiments of the present disclosure, methods for constructing the large insert-size library are not subjected to special restriction. According to the specific embodiment of the present disclosure, the method for large insert-size library may comprise following steps:

(1) Randomly breaking

The vector inserted with DNA to be analyzed is subjected to breaking, to obtain randomly breaking fragments having lengths longer than that of the vector. Then, the obtained randomly breaking fragments are subjected to treatment of end-repairing, to the blunt end of the obtained randomly breaking fragments. The vector may be a plasmid. Specifically, the plasmid may be fosmid plasmid, BAC plasmid, or cosmid plasmid, etc.

(2) Separating.

The randomly breaking fragments after the treatment of end-repaired obtained in (1) are subjected to separation, to obtain randomly breaking fragments having lengths more than that of the vector.

(3) Cyclizing.

The randomly breaking fragments obtained in (2) are subjected to self-linkage to forming cyclic molecules, and then the fragments which self-linking unsuccessfully are removed.

(4) Amplification.

Primers are designed according to the sequence of vector, then the detected nucleic acid fragments existing in the cyclic molecules are amplified (e.g., the end sequences of the nucleic acid fragments to be analyzed in (1)).

S404, end-sequencing the large insert-size library.

Specifically, the amplification products obtained in (4) are subjected to end-repairing, to blunt the ends of the obtained randomly breaking fragments. And then adaptors for sequencing are added. A Next-Generation sequencing platform is selected for sequencing, to guarantee the coverage of genome needed, the total amount of bases obtained from sequencing need to be more than 3 times of the size of genome.

S406, filtering the short-fragment-sequence output from end sequencing of the large insert-size library to remove unqualified sequence.

S408, aligning the filtered short-fragment-sequences to a reference genome sequence.

S410, sorting the paired short-fragment-sequences after alignment into soap reads sequence, single reads sequence and unmap reads sequence based on the aligning result, and counting the number of each sort of sequence.

S412, calculating a distance between the paired soap reads on a fragment of the reference genome sequence, wherein a pair of the paired soap reads can be aligned onto a same fragment of the reference genome sequence; and counting a distance distribution of each pair of soap reads on the reference genome sequence.

S414, assembling the genome sequence by using the unique paired single reads upon the distance distribution meeting a requirement of a threshold, wherein a pair of the unique paired single reads can be uniquely aligned onto two different fragments of the reference genome.

This embodiment incorporates a method for constructing an large insert-size library (e.g., fosmid, BAC, etc.) and a Next-Generation sequencing technology, effectively utilizes characteristics of low-cost and fast speed on constructing genome by the Next-Generation sequencing technology, takes advantage of the length of the inserted fragment in the library fosmid or BAC being much longer than that of the common library-constructing method, and using the sequencing data containing longer-distance sequence-topological-relationship to construct longer genome fragment, which significantly improve the quality of the genome map.

In a further embodiment of the method for genome assembly in the present disclosure, Chromosome X in Drosophila genome is taken as an example, the source of the reference genome sequence is: The National Center for Biotechnology Information, the web site is: www.ncbi.nlm.nih.gov/, the No. of genome is: gi|116010291|ref|NC_004354.3| Drosophila melanogaster chromosome X, complete sequence.

Chromosome C in Drosophila genome may be subjected to simulated sequencing by using Maq simulate software, the result obtained by sequencing is taken as sequencing data. And, parameters of Maq simulated software need to be preset as following: —d, —N, —1, —2, fq1, fq2 and simupars.dat.

Next, specification to each parameter is described in detail: parameter —d is length of sequencing fragment, which is separately set as 500, 2000, 5000, 40000; parameter —N indicates total number of the short-fragment-sequences to be obtained by sequencing, which is determined by sequencing depth. The sequencing depth is one of the indicator for assessing quality of sequencing, which indicates a ratio between the total amount of bases obtained by sequencing and the size of genome, and is obtained by calculating according to a formula: N=sequencing depth×total length of the reference genome/(2×the length of reads). The simulated sequencing depth in this embodiment is 50× (namely, 50 times of the length of the reference genome), the total length of the reference genome is 22 M, and the length of the short-fragment-sequence is set as 100 bp; parameter —1 and —2 are lengths of short-fragment-sequences subjecting to alignment, which are both set as 100 by in this embodiment; fq1 and fq2 are output documents, the sequencing data after simulating sequencing (namely, the short-fragment-sequence 1 and the short-fragment-sequence 2) are saved in document fa1 and document fa2 respectively as fasta. format; simupars.dat is a system document of maq simulate software, which determine the length and quality value of the short-fragment-sequences.

In such embodiment, various common software for short-fragment-sequences alignment (such as SOAP, BWA, etc.) may be used to subject these sequences to a reference genome of a corresponding species to similarity alignment. The length of the fragments to be subjected to alignment can be essentially the same, with an allowance of a certain ranges (the ranges may be set by the user according to requirements, for example the ranges may be set as 10%). The short-fragment-sequences obtained having a length within the normal range are known as normal short-fragment-sequences, otherwise are known as abnormal short-fragment-sequences, the minimum length of the short-fragment-sequences is 40 bp. The maximum number of mismatching within one short-fragment-sequence should be as low as possible, to guarantee the precision of alignment.

In this embodiment, software used for alignment is SOAP2, parameters are preset as following when performing alignment: —p, —a, —b, —D, —o, —2, —u, —m, —x, —s, —1, —v.

Next, specification to each parameter is described in detail: parameter —p indicates RAM needed when operating such action script; parameter —a indicates that input document is fq1 document (document of short-fragment-sequence 1) obtained by re-sequencing of pair-end sequencing; parameter —b indicates that input document is fq2 document (document of short-fragment-sequence 2) obtained by re-sequencing of pair-end sequencing; parameter —D indicates that reference genome is input as a format of fasta. document (wherein, the first line of fasta sequence document is any literal statement started with a greater-than sign “>” or a semicolon “;”, for labeling the sequence; from the second line is sequence itself, which only permits usage of the preset nucleotides or amino acids); there are 3 output parameters, parameter -o, the output result is that paired short-fragment-sequence can be aligned onto reference genome sequence, with “.soap” as a suffix of the output document; parameter —2, the output result thereof is that only one of two paired short-fragment-sequences can be aligned onto reference genome reference, which “.single” as a suffix of the output document; parameter —u, the output result thereof is that none of two paired short-fragment sequence can be aligned onto reference genome sequence, with “.unmap” as a suffix of the output document; parameter —t is not preset for retaining the original ID number of the short-fragment-sequences; parameters —m and —x are ranges of the inserted fragments, parameter —m refers to the lower limitation of the sequencing reads, namely, minus percentage×length of the sequencing fragment, parameter —x refers to the higher limitation of the sequencing reads, namely, positive percentage×length of the sequencing reads. In such embodiments, to seek out qualified short-fragment-sequences at a maximum range, the ranges for sequencing reads are being less restricted, parameters —m and —x are preset as ±0.88×length of sequencing reads as the ranges of sequencing reads; parameter —s is the minimum aligning length, which is preset as 40; parameter —1 is length of seed sequences that can be aligned initially (since mismatching rate is high at the 3′-end of large-insert-fragments, a certain length of sequence at 5′-end is preset as seed sequence), which is preset as 32; parameter —v indicates the maximum number of mismatching of a short-fragment-sequence during alignment, in such embodiments the parameter —v should be preset as low as possible, to guarantee the precision of alignment. In addition, the consistence of SOAP parameters should be noted.

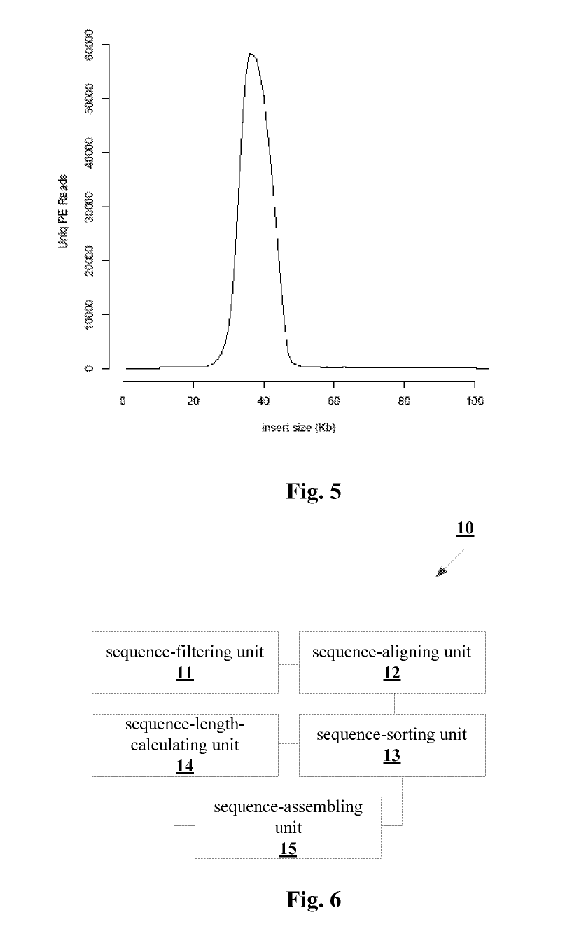

As shown in FIG. 5, X-axis “insert size (kb)” indicates “length of the inserted fragment”, Y-axis “Uniq PE Reads” indicates “unique reads of pair-end-sequencing”. These data are subjected to analyzing for the size of the library of inserted-fragment, and the result turns out that the size of the inserted fragment is normal with an acceptable ranges. The genome sequence is subjected to auxiliary assembly by using the sequence information of paired reads which can be aligned onto different assembled-fragments of reference genome. The N50 result of simulated assembly of Drosophila melanogaster genome is increased from 0.32 M to 1.48 M.

In an additional embodiment of the method for genome assembly in the present disclosure, firstly, genomic DNA of a Yun Ling black goat is broken randomly to ensure the length of the broken DNAs being no less than 36 kb, and a fosmid library of Yun Ling black goat is obtained by process of separation, cyclization and amplification. And then, 14.4 M pairs of original sequencing-short-sequences (pair-end sequencing reads) have been obtained by a Next-Generation sequencing technology. The high-throughput sequencing technology may be Illumina GA sequencing technology, or may also be other existing high-throughput sequencing technology.

Next, the adaptor sequences and the ends of the data with poor quality are removed by using bioinformatics methods, and then the sequences repeatedly sequenced were removed and finally 2,611,182 pairs of reads having unique characteristic were obtained. In these reads, having unique characteristic, there are 1,589,054 pairs of reads which can be uniquely aligned onto a same scaffold (assembled-fragment of genome). Among them, the number of the unique paired reads which has a distance less than 500 by on a scaffold is 338,255 pairs, the number of the unique paired reads which has a distance being more than 10 kb on a scaffold is 232,544 pairs, and there are 206,697 pairs of unique paired reads having a length of 30 kb to 50 kb accounting for 86.42%. These data are subjected to analysis for the size of the library, and the result turns out that the size of the inserted fragment is normal within acceptable ranges. The number of sequences which can be aligned onto different scaffolds is 18,255 pairs, and the genome sequence is subjected to auxiliary assembly by using these 18,255 pairs of sequences. The N50 assembly result of Yun Ling black goat is increased from 2.2 M to 3.1 M.

In a further embodiment of the method for genome assembly in the present disclosure, firstly, genome DNA of Polar Bear is broken randomly to ensure the length of the broken DNA being no less than 36 kb, and a fosmid library of Polar Bear is obtained by process of separation, cyclization and amplification. And then, 14.4 M pairs of original sequencing-short-sequences (pair-end reads) have been obtained by a Next-Generation sequencing technology. The high-throughput sequencing technology may be Illumina GA sequencing technology, or may also be other existing high-throughput sequencing technology.

Next, the adaptor sequences and the ends of the data with poor quality are removed by using bioinformatics methods, and then the sequences repeatedly sequenced has been removed and finally 15,225,082 pairs of reads has been obtained. In these 15,225,082 pairs of reads, there are 2,865,235 pairs of unique paired reads which can be uniquely aligned onto a same scaffold, among them, the number of the unique paired reads which have a distance being less than 500 by is 209,600 pairs, the number of the unique paired reads which have a distance more than 10 kb on a scaffold is 531,028 pairs, and there are 520,897 pairs of unique paired reads having a length of 30 kb to 50 kb accounts for 98.09%. The number of sequences which can be aligned onto different scaffolds is 185,888 pairs, and the genome is subjected to auxiliary assembly by using these 185,888 pairs of sequences. The N50 assembly result of Polar Bear is increased from 2.3 M to 6.5 M.

Next, an apparatus for genome assembly according to embodiments of the present disclosure are described in detail referring to FIG. 6. As shown in FIG. 6, the apparatus 10 may comprise: a sequence-filtering unit 11, a sequence-aligning unit 12, a sequence-sorting unit 13, a sequence-length-calculating unit 14 and a sequence-assembling unit 15. According to the embodiments of the present disclosure, the sequence-filtering unit 11 is used for filtering a short-fragment-sequence output from end sequencing of a large insert-size library to remove unqualified sequences. The unqualified sequences may comprise at least one selected from a group consisting of: an exogenous sequence, a short-fragment-sequence having a preset ratio of the number N bases, a short-fragment-sequence comprising poly A, a short-fragment-sequence having a preset ratio of the number of low-quality bases, a short-fragment-sequence having a contaminant form adaptor, a short-fragment-sequence having an overlap with its paired short-fragment-sequence, and a short-fragment-sequence repeatedly detected. According to embodiments of the present disclosure, the sequence-aligning unit 12 which is connected to the sequence-filtering unit 11 is used for aligning the filtered short-fragment-sequence to a reference genome sequence. According to embodiments of the present disclosure, the sequence-sorting unit 13 which is connected to the sequence-aligning unit 12 is used for sorting the paired short-fragment-sequences after alignment into soap reads sequence, single reads sequence and unmap reads sequence based on the aligning result, and counting the number of each sort of sequence. The soap reads sequences may refer to paired short-fragment-sequences which can be aligned onto a same assembled-fragment of the genome; the single reads sequences may refer to paired short-fragment-sequences which can be aligned onto different assembled-fragments of the genome; the unmap reads sequence may refer to paired short-fragment-sequences which neither of the two short-fragment-sequence can be aligned onto assembled-fragment of the genome. According to embodiments of the present disclosure, the sequence-length-calculating unit 14 which is connected to the sequence-sorting unit 13 is used for calculating a distance between the paired soap reads on a fragment of the reference genome sequence, wherein a pair of the paired soap reads can be aligned onto a same fragment of the reference genome sequence; and counting a distance distribution of each pair of soap reads on the reference genome sequence. According to embodiments of the present disclosure, the sequence-assembling unit 15 which is connected to the sequence-sorting unit 13 and the sequence-length-calculating unit 14 is used for assembling the genome by using the paired single reads upon the distance distribution meeting a requirement of a threshold, wherein a pair of the paired single reads can be aligned onto two different fragments of the reference genome sequence. Specifically, the genome is subjected to assembly by connecting the adjacent genome fragments according to the intrinsic sequence-length and spatial relationship of the sequencing library.

By using the apparatus for genome assembly according to embodiments of the present disclosure, the above-mentioned method for genome assembly may be effectively implemented. Accordingly, since such embodiment uses the large insert-size-library, longer fragments (longer scaffolds) of the genome may be constructed by using sequencing data containing sequence-relationships with longer distance than the prior art, and then the effect of the genome assembly is further improved.

According to embodiments of the present disclosure, the soap reads sequence may comprise: paired reads can be uniquely aligned onto a same fragment of the reference genome sequence, and paired reads can be non-uniquely aligned onto a same fragment of the reference genome. Accordingly, the unique paired soap reads may be further utilized to calculate the distance between them on a fragment of the reference genome. According to embodiments of the present disclosure, such calculating performance may be carried out by the sequence-length-calculating unit 14.

In such embodiment, the distance between the unique paired soap reads on the same fragment of the reference genome is calculated, wherein a pair of the unique paired soap reads can be uniquely aligned onto a same fragment of the reference genome. Accordingly, the quality of the large insert-size-library may be precisely counted. Libraries with higher quality are good for precise assembly.

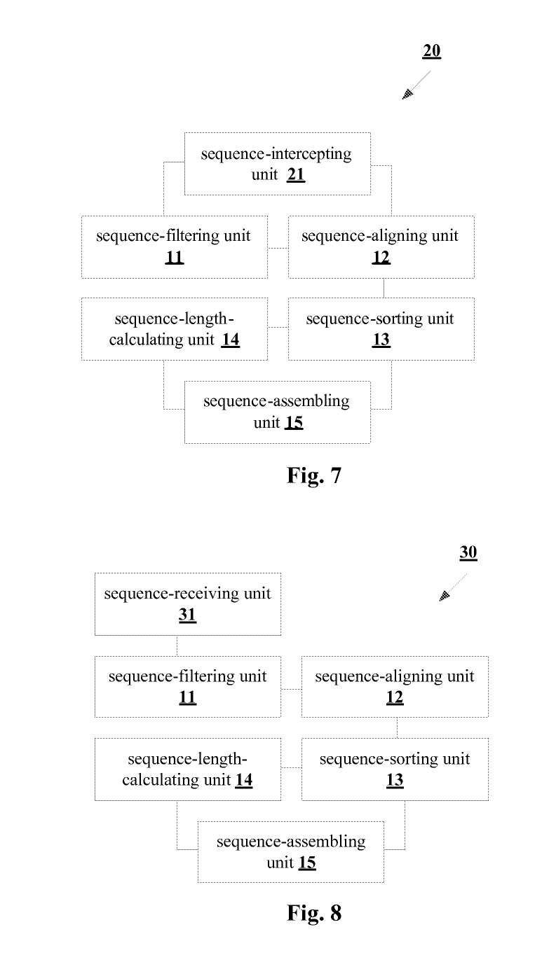

Apparatus for genome assembly according to another embodiment of the present disclosure is described in detail referring to FIG. 7. As shown in FIG. 7, the apparatus 20 may further comprise a sequence-intercepting unit 21 based on the apparatus 10 shown in FIG. 6. The sequence-intercepting unit 21 which is connected to the sequence-filtering unit 11 and the sequence-aligning unit 12 is used for intercepting the filtered short-fragment-sequences to short-fragment-sequences with a preset length before alignment, wherein the minimum length for alignment is 40 bp.

In such embodiment, the length of fragments to be aligned is subjected to a certain restriction which requires the length of fragments to be aligned within preset ranges, thus the precision and the efficiency of the alignment may be guaranteed.

FIG. 8 is a schematic diagram of the apparatus for genome assembly according to a further embodiment of the present disclosure. As shown in FIG. 8, the apparatus for genome assembly 30 may comprise a sequence-receiving unit 31 based on the apparatus 10 shown in FIG. 6. The sequence-receiving unit 31 which is connected to the sequence-filtering unit 11 is used for receiving the pair-end reads after the step of end-sequencing large insert-size library.

To be noted, the term “connect” used herein should be broadly understood, it may be a direct linkage, or may be an indirect linkage, as long as it may achieve a functional linkage.

To be noted, the method and the apparatus for genome assembly have been described in multiple embodiments of the present disclosure. It would be appreciated by those skilled in the art that each technical feature in specific embodiment may be applied to other embodiments directly or with adaptable transformation.

### INDUSTRIAL APPLICABILITY

The method and the apparatus for genome assembly according to embodiments of the present disclosure can be used for genome assembly. Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

What is claimed is:

1. A method for genome assembly comprising:
filtering a short-fragment-sequence output from end sequencing of a large insert-size library to remove unqualified sequences, the qualified sequences comprising filtered short-fragment-sequences;
aligning the filtered short-fragment-sequences to a reference genome sequence, wherein the filtered short-fragment-sequences comprise paired short-fragment-sequences;
sorting the paired short-fragment-sequences after alignment into soap reads sequences, single reads sequences, and unmap reads sequences based on an aligning result, and counting the number of each sort;
calculating a distance between the paired soap reads on a fragment of the reference genome sequence, wherein a pair of the paired soap reads can be aligned onto a same fragment of the reference genome sequence; and counting a distance distribution of each pair of soap reads on the reference genome sequence; and
assembling a genome sequence by using the paired single reads upon the distance distribution meeting a requirement of a threshold, wherein a pair of the paired single reads can be aligned onto two different fragments of the reference genome sequence.

2. The method according to claim 1, wherein before aligning the filtered short-fragment-sequences to the reference genome sequence further comprises the step of:
intercepting the filtered short-fragment-sequences to short-fragment-sequences with a preset length.

3. The method according to claim 1, wherein the unqualified sequences comprise at least one selected from a group consisting of: an exogenous sequence, a short-fragment-sequence having a preset ratio of a number N bases, a short-fragment-sequence comprising poly A, a short-fragment-sequence having a preset ratio of a number of low-quality bases, a short-fragment-sequence having a contaminant from adaptor, a short-fragment-sequence having an overlap with its paired short-fragment-sequence, and a short-fragment-sequence repeatedly detected.

4. The method according to claim 1, wherein the soap reads sequence comprises:
paired reads can be uniquely aligned onto a same fragment of the reference genome sequence, and
paired reads can be non-uniquely aligned onto a same fragment of the reference genome sequence,
the step of calculating a distance between the paired soap reads on a fragment of the reference genome sequence, wherein a pair of the paired soap reads can be aligned onto a same fragment of the reference genome sequence, further comprising:
calculating the distance between the paired soap reads uniquely aligned onto a same fragment of the reference genome sequence.

5. The method according to claim 1 further comprising
constructing a large insert-size-sequence library; and
end-sequencing the large insert-size-sequence library to obtain output short-fragment-sequences.

6. An apparatus for genome assembly comprising:
a sequence-filtering unit for filtering a short-fragment-sequence output from end sequencing of a large insert-size library to remove unqualified sequences;
a sequence-aligning unit, connected to the sequence-filtering unit, for aligning the filtered short-fragment-sequences to a reference genome sequence, wherein the filtered short-fragment-sequences comprise paired short-fragment-sequences;
a sequence-sorting unit, connected to the sequence-aligning unit, for sorting the paired short-fragment-sequences after alignment into a soap reads sequence, a single reads sequence, and an unmap reads sequence based on an aligning result, and counting a number of each sort of sequences;
a sequence-length-calculating unit, connected to the sequence-sorting unit, for calculating a distance between the paired soap reads on a fragment of the reference genome sequence, wherein a pair of the paired soap reads can be aligned onto a same fragment of the reference genome sequence, and counting a distance distribution of each pair of soap reads on the reference genome sequence; and
a sequence-assembling unit, respectively connected to the sequence-sorting unit and the sequence-length-calculating unit, for assembling the genome by using the paired single reads upon the distance distribution meeting a requirement of a threshold, wherein a pair of the paired single reads can be aligned onto two different fragments of the reference genome sequence.

7. The apparatus according to claim 6 further comprising:
a sequence-intercepting unit, respectively connected to the sequence-filtering unit and the sequence-aligning unit, for intercepting the filtered short-fragment-sequences to short-fragment-sequences with a preset length before aligning the filtered short-fragment-sequence to the reference genome sequence.

8. The apparatus according to claim 6, wherein the unqualified sequences comprise at least one selected from a group consisting of: an exogenous sequence, a short-fragment-sequence having a preset ratio of the number N bases, a short-fragment-sequence comprising poly A, a short-fragment-sequence having a preset ratio of the number of low-quality bases, a short-fragment-sequence having a contaminant from adaptors, a short-fragment-sequence having an overlap with its paired short-fragment-sequence, and a short-fragment-sequence repeatedly detected.

9. The apparatus according to claim 6, wherein the soap reads sequence comprises:
paired reads can be uniquely aligned onto a same fragment of the reference genome sequence, and
paired reads can be non-uniquely aligned onto a same fragment of the reference genome sequence,
wherein the sequence-length-calculating unit further comprises:
calculating the distance between the paired soap reads uniquely aligned onto a same fragment of the reference genome;
counting the distance distribution of the each pair of unique soap reads on the reference genome sequence;
wherein the sequence-assembling unit further comprises:
assembling the genome by using the unique paired single reads upon the distance distribution meeting a requirement of a threshold, wherein a pair of the unique paired single reads can be uniquely aligned onto two different fragments of the reference genome.

10. The apparatus according to claim 6 further comprising:
a sequence-receiving unit, connected to the sequence-filtering unit, for receiving the short-fragment-sequences after the step of end-sequencing the large insert-size library.
